(19) United States
(12) Patent Application Publication
(10) Pub. No.: US 2018/0285875 A1
(43) Pub. Date: Oct. 4, 2018

(54) STATIC TOKEN SYSTEMS AND METHODS FOR REPRESENTING DYNAMIC REAL CREDENTIALS

(71) Applicants: Simon Law, San Mateo, CA (US); Jai Dandekar, Foster City, CA (US); Wuthichai Lee, Union City, CA (US); Dheeraj Sunkavalli, Newark, CA (US); Robert Warfel, Foster City, CA (US)

(72) Inventors: Simon Law, San Mateo, CA (US); Jai Dandekar, Foster City, CA (US); Wuthichai Lee, Union City, CA (US); Dheeraj Sunkavalli, Newark, CA (US); Robert Warfel, Foster City, CA (US)

(21) Appl. No.: 15/476,160

(22) Filed: Mar. 31, 2017

(51) Int. Cl. G06Q 20/40; G06Q 20/38

(52) U.S. Cl. CPC G06Q 20/4014; G06Q 2220/00; G06Q 20/382

(57) ABSTRACT

Systems and methods are provided for pre-provisioning a first device with a token. The token on the first device may be linked to any real credential using an application on a second device. Because the token may be maintained using the second device, the first device may be a “dumb” device while the second device is a “smart” device. The real credential may be changed and updated on the second device, such that the same token is linked to different real credentials at different times. An identifier may be assigned to the first device and stored in association with its provisioned token in a token vault. The identifier may be used by a user to register and activate the token with the application on the second device.

### CROSS-REFERENCES TO RELATED APPLICATIONS

None.

### BACKGROUND

A transaction is typically authorized by a user at the time the transaction is requested from a resource provider. For example, a cardholder may authorize a purchase at a point of sale. The user's real credential, such as a primary account number (PAN), access number, or PIN number, may be communicated by a device utilized to conduct the transaction (e.g., a credit card, a mobile device, a communication device, a security device, etc.). However, users may not want to share their real credentials with resource providers due to security concerns.

Therefore, secure and efficient systems and methods are needed to provide more users with the capability to conduct transactions using their devices, while keeping their real credentials hidden from resource providers. This reduces the risk both of fraud by the resource provider, as well as interception and misuse of the real credentials by reducing the number of parties to which the real credentials are communicated.

To accomplish this, tokens may be provisioned onto devices and utilized in place of the real credentials to conduct transactions with resource providers. A token may be used to substitute sensitive information (i.e., a real credential) with a non-sensitive equivalent that has little or no value in itself. The token may act as a reference that maps back to the real credential through a token server. The token server may be highly secured and totally isolated from other transaction processing entities, such as resource providers, reducing the risk of fraud and interception of the real credential by unauthorized parties.

Typically, tokens are provisioned onto enhanced functionality devices for use in conducting transactions. An enhanced functionality device may be a device that has access to the Internet and that has a sophisticated user interface (e.g., a smartphone, a tablet, a computer, etc.). The enhanced functionality devices may be used to request tokens corresponding to real credentials and to provision the tokens onto the devices in real time. An enhanced functionality device may store a plurality of tokens corresponding to a plurality of real credentials.

Limited functionality devices may be devices that do not have direct access to the Internet and/or that do not have sophisticated (or any) user interfaces (e.g., wearable devices, such as fitness bands, rings, basic mobile phones, key fobs, etc.). Limited functionality devices may be pre-provisioned (i.e, manufactured) with real credentials, but the provisioned real credentials are generally static and cannot be further altered. Thus, a user may be unable to replace the pre-provisioned real credential with a different real credential. This may present problems for the user upon expiration or cancellation of the pre-provisioned real credential, when obtaining a new real credential, or when use of a different real credential is desirable. If the user desires to have more than one provisioned real credential, a plurality of limited functionality devices, each pre-provisioned with a different real credential, may be required.

Embodiments of the invention address this and other problems, individually and collectively.

### SUMMARY

According to some embodiments of the invention, systems and methods are provided for pre-provisioning a first device with a token. The token on the first device may be linked to any real credential using an application on a second device. Because the token may be maintained using the second device, the first device may be a limited functionality device while the second device is an enhanced functionality device. The real credential may be changed and updated on the second device, such that the same token is linked to different real credentials at different times. An identifier may be assigned to the first device and stored in association with its provisioned token in a token vault. The identifier may be used by a user to register and activate the token with the application on the second device.

According to some embodiments of the invention, a method is provided. The method comprises receiving, by a server computer, a first device identifier associated with a first device from a second device. The first device identifier is stored in association with a token. The token is pre-provisioned in the first device. The method further comprises receiving, by the server computer, a real credential from the second device. The method further comprises linking, by the server computer, the real credential and the token. The method further comprises facilitating, by the server computer, activation of the token. The token is thereafter used by the first device to interact with an access device in a transaction.

Embodiments of the invention are further directed to a server computer comprising a processor and a non-transitory computer readable medium. The computer readable medium can comprise code, executable by the processor, for implementing any of the methods described herein.

These and other embodiments of the invention are described in further detail below.

### BRIEF DESCRIPTION OF THE DRAWINGS

FIG. 1 shows a block diagram of a transaction system for processing static tokens representing dynamic real credentials according to some embodiments of the present invention.

FIG. 2 shows a block diagram of a first device pre-provisioned with a static token according to some embodiments of the present invention.

FIG. 3 shows a block diagram of a second device for maintaining the static token according to some embodiments of the present invention.

FIG. 4 shows a block diagram of an application provider computer according to some embodiments of the present invention.

FIG. 5 shows a block diagram of a token server according to some embodiments of the present invention.

FIG. 6 shows a flow diagram of a transaction method for processing static tokens representing dynamic real credentials according to some embodiments of the present invention.

FIG. 7 shows a block diagram of a building access system according to some embodiments of the present invention.

### DETAILED DESCRIPTION

According to some embodiments of the invention, systems and methods are provided that allow users to use a first device pre-provisioned with a static token to perform transactions, without requiring the use of the Internet or a sophisticated user interface on the first device. A second device may be used to maintain the pre-provisioned token, such as to register the token, to associate the token with a real credential, and/or to change the real credential that is associated with the token.

Before discussing specific embodiments and examples, some descriptions of terms used herein are provided below.

An “access device” may be any suitable device that provides access to a remote system. An access device may also be used for communicating with a merchant computer, a transaction processing computer, an authentication computer, or any other suitable system. An access device may generally be located in any suitable location, such as at the location of a merchant. An access device may be in any suitable form. Some examples of access devices include POS or point of sale devices (e.g., POS terminals), cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, and the like. An access device may use any suitable contact or contactless mode of operation to send or receive data from, or associated with, a user mobile device. In some embodiments, where an access device may comprise a POS terminal, any suitable POS terminal may be used and may include a reader, a processor, and a computer-readable medium. A reader may include any suitable contact or contactless mode of operation. For example, exemplary card readers can include radio frequency (RF) antennas, optical scanners, bar code readers, or magnetic stripe readers to interact with a payment device and/or mobile device. The POS terminal may or may not initiate processing of transactions.

An “acquirer” may typically be a business entity (e.g., a commercial bank) that has a business relationship with a particular merchant or other entity. Some entities can perform both issuer and acquirer functions. Some embodiments may encompass such single entity issuer-acquirers. An acquirer may operate an acquirer computer, which can also be generically referred to as a “transport computer”.

An “authorization request message” may be an electronic message that is sent to a payment processing network and/or an issuer of a payment card to request authorization for a transaction. An authorization request message according to some embodiments may comply with (International Organization of Standardization) ISO 8583, which is a standard for systems that exchange electronic transaction information associated with a payment made by a consumer using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), an expiration date, etc. An authorization request message may also comprise “transaction information,” such as any information associated with a current transaction, such as the transaction amount, merchant identifier, merchant location, etc., as well as any other information that may be utilized in determining whether to identify and/or authorize a transaction.

An “authorization response message” may be an electronic message reply to an authorization request message generated by an issuing financial institution or a payment processing network. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the payment processing network) to the merchant's access device (e.g. POS equipment) that indicates approval of the transaction. The code may serve as proof of authorization. As noted above, in some embodiments, a payment processing network may generate or forward the authorization response message to the merchant.

An “authorizing entity” may be an entity that authorizes a request. Examples of an authorizing entity may be an issuer, a governmental agency, a document repository, an access administrator, etc.

A “device” may comprise any suitable electronic device that may be operated by a user. In some embodiments, a device may be a limited functionality device. A limited functionality device may be a device that does not have access to the Internet and/or does not have a sophisticated user interface (or does not have a user interface at all). However, a limited functionality device may have certain communication capabilities other than Internet capabilities, such as through Bluetooth or near field communication, for example. In some embodiments, a device may be an enhanced functionality device. An enhanced functionality device may be a device that has access to the Internet and/or has a sophisticated user interface (e.g., a touch screen). A device may include a communication device. A communication device may provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network. Examples of devices include mobile phones (e.g., cellular phones), PDAs, tablet computers, net books, laptop computers, personal music players, handheld specialized readers, watches, fitness bands, wearables, ankle bracelets, rings, earrings, key fobs, physical wallets, glasses, containers, coffee mugs, takeout containers, etc., as well as automobiles with remote communication capabilities. A device may comprise any suitable hardware and software for performing such functions, and may also include multiple devices or components (e.g., when a device has remote access to a network by tethering to another device—i.e., using the other device as a modem—both devices taken together may be considered a single communication device).

A “digital wallet” can include an electronic application or device that allows an individual to conduct electronic commerce transactions. A digital wallet may store user profile information, payment credentials, bank account information, one or more digital wallet identifiers, and/or the like, and can be used in a variety of transactions, such as but not limited to eCommerce, social networks, money transfer/personal payments, mobile commerce, proximity payments, gaming, and/or the like for retail purchases, digital goods purchases, utility payments, purchasing games or gaming credits from gaming websites or systems, transferring funds between users, and/or the like. A digital wallet may be designed to streamline the purchase and payment process. A digital wallet may allow the user to load one or more payment cards onto the digital wallet so as to make a payment without having to enter an account number or present a physical card. A digital wallet may also store transaction records (e.g., electronic receipts).

An “identifier” can include any combination of letters, numbers, symbols and/or images identifying something. Examples of these identifiers include MAC addresses, IP addresses, serial numbers, QR codes, bar codes, passwords, PIN numbers, names, and the like. An identifier may be associated with a device. For example, a “device identifier” may be an identifier unique to a particular device.

An “issuer” may typically refer to a business entity (e.g., a bank) that maintains an account for a user. An issuer may also issue payment credentials stored on communications devices.

“Provisioning” may include a process of providing data for use. For example, provisioning may include providing, delivering, or enabling a token on a device. Provisioning may be completed by any entity within or external to the transaction system. For example, in some embodiments, tokens may be provisioned by an issuer or a transaction processing network onto a mobile device. The provisioned tokens may have corresponding token data stored and maintained in a token vault or token registry. In some embodiments, a token vault or token registry may generate a token that may then be provisioned or delivered to a device. “Pre-provisioning” may include a process of providing data on a device before the device is purchased, used, and/or obtained. For example, pre-provisioning may include providing, delivering, or enabling a token on a device when the device is manufactured.

A “real credential” may comprise any evidence of authority, rights, or entitlement to privileges. For example, access credentials may comprise permissions to access certain tangible or intangible assets, such as a building or a file. In another example, payment credentials may include any suitable information associated with and/or identifying an account (e.g., a payment account and/or a payment device associated with the account). Such information may be directly related to the account or may be derived from information related to the account. Examples of account information may include an “account identifier” such as a PAN (primary account number or “account number”), a token, a subtoken, a gift card number or code, a prepaid card number or code, a user name, an expiration date, a CVV (card verification value), a dCVV (dynamic card verification value), a CVV2 (card verification value 2), a CVC3 card verification value, etc. An example of a PAN is a 16-digit number, such as “4147 0900 0000 1234”. In some embodiments, real credentials may be considered sensitive information.

A “resource provider” may be an entity that can provide a resource such as goods, services, information, and/or access. Examples of a resource provider include merchants, access devices, secure data access points, etc. A “merchant” may typically be an entity that engages in transactions and can sell goods or services, or provide access to goods or services.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

A “service provider” or “application provider” may be an entity that can provide a service or application. An example of a service provider is a digital wallet provider.

A “token” may include a substitute identifier for some information. For example, a payment token may include an identifier for a payment account that is a substitute for an account identifier, such as a primary account number (PAN). For instance, a token may include a series of alphanumeric characters that may be used as a substitute for an original account identifier. For example, a token “4900 0000 0000 0001” may be used in place of a PAN “4147 0900 0000 1234.” In some embodiments, a token may be “format preserving” and may have a numeric format that conforms to the account identifiers used in existing payment processing networks (e.g., ISO 8583 financial transaction message format). In some embodiments, a token may be used in place of a PAN to initiate, authorize, settle or resolve a payment transaction. The token may also be used to represent the original credential in other systems where the original credential would typically be provided. In some embodiments, a token value may be generated such that the recovery of the original PAN or other account identifier from the token value may not be computationally derived. Further, in some embodiments, the token format may be configured to allow the entity receiving the token to identify it as a token and recognize the entity that issued the token.

“Tokenization” is a process by which sensitive data is replaced with substitute data. For example, a real credential (e.g., a primary account number (PAN)) may be tokenized by replacing the real account identifier with a substitute number that may be associated with the real credential. Further, tokenization can be applied to any other information to substitute the underlying information with a token. “Token exchange” or “de-tokenization” is a process of restoring the data that was substituted during tokenization. For example, a token exchange may include replacing a payment token with its associated primary account number (PAN). Further, de-tokenization or token exchange may be applied to any other information to retrieve the substituted information from a token. In some embodiments, token exchange can be achieved via a transactional message, such as an ISO message, an application programming interface (API), or another type of web interface (e.g., web request).

A “transaction processing computer” may include a network of one or more devices that can process and route transaction request messages. An exemplary transaction processing computer may include data processing subsystems, networks, and operations used to support and deliver authorization services, exception file services, transaction scoring services, and clearing and settlement services. An exemplary transaction processing system may include VisaNet™. Transaction processing systems such as VisaNet™ are able to process credit card transactions, debit card transactions, and other types of commercial transactions. VisaNet™, in particular, may include a VIP system (Visa Integrated Payments system) which processes authorization requests and a Base II system which performs clearing and settlement services.

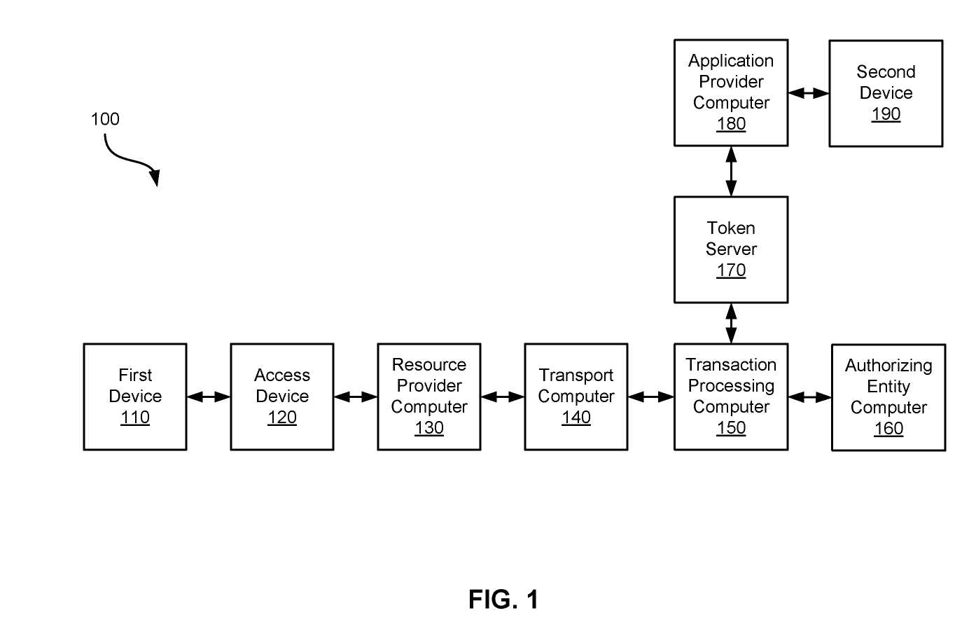

Various systems may be used to implement the methods of processing static tokens described herein. FIG. 1 shows a block diagram of a system 100 for processing static tokens representing dynamic real credentials according to some embodiments of the present invention. The system 100 includes a first device 110, an access device 120, a resource provider computer 130, a transport computer 140, a transaction processing computer 150, an authorizing entity computer 160, a token server 170, an application provider computer 180, and a second device 190. Each of these systems and computer may be in operative communication with each other. In some embodiments, the first device 110 and the second device 190 may be operated by a same user (e.g., an authorized user of a real credential). In some embodiments, the first device 110 and the second device 190 may be operated by different users (e.g., the second device 190 may be operated by a parent to activate a token provisioned on the first device 110 for a child).

For simplicity of illustration, a certain number of components are shown in FIG. 1. It is understood, however, that embodiments of the invention may include more than one of each component. In addition, some embodiments of the invention may include fewer than or greater than all of the components shown in FIG. 1. In addition, the components in FIG. 1 may communicate via any suitable communication medium (including the Internet), using any suitable communications protocol.

A user may operate the second device 190 to activate and manage a token pre-provisioned on the first device 110. The first device 110 may have a first device identifier (e.g., a serial number). The first device identifier may, in some embodiments, be covered by packaging or protected with a scratch-off label or other removable label. A user may reveal the first device identifier, then operate the second device 190 to send the first device identifier associated with the first device 110 to an application provider computer 180. A user may further operate the second device 190 to select a real credential to associate with the token pre-provisioned on the first device 110, and send the selection to the application provider computer 180.

Each of the first device 110 and the second device 190 may be any device suitable to carry out transactions, such as financial transactions, or any other additional related actions. One or both of the first device 110 and the second device 190 may include a memory that may store a digital wallet application or other payment application. The application may be provisioned with account information (e.g., a credential or token) to enable each device to conduct transactions (e.g., sending and receiving money). Each of the first device 110 and the second device 190 may also include a secure element that can be implemented in either hardware and/or software, which may store sensitive account or personal information.

In some embodiments, the first device 110 may be a limited functionality device, and the second device 190 may be an enhanced functionality device. In some embodiments, the first device 110 and the second device 190 may both be enhanced functionality devices. An enhanced functionality device may be a device that has access to the Internet and/or that has a sophisticated user interface (e.g., a smartphone, a tablet, a computer, etc.). A limited functionality device may be a device that does not have direct access to a remote network (e.g., the Internet) and/or that does not have a sophisticated (or any) user interface (e.g., wearable devices, such as fitness bands and rings, basic mobile phones, key fobs, access cards, programmable cards, etc.).

The application provider computer 180 may receive the first device identifier and the selected real credential from the second device 190. The application provider computer 180 may retrieve the token corresponding to the first device identifier from a database, such as by using a look-up table. The application provider computer 180 may forward the token and the selected real credential to the token server 170.

The application provider computer 180 may be operated or associated with an application provider. The application provider may be an entity that provides an application to a communication device for use by a user. In some embodiments, the application provider can be a digital wallet provider that provides a digital wallet or payment application to a communication device. The application provider computer 180 may maintain one or more digital wallets for each user, and each digital wallet may be associated with payment data for one or more payment accounts. Examples of digital wallets may include Visa Checkout™ or Google™ Wallet, etc.

The application provider computer 180 may comprise a server computer. The server computer may include a processor and a computer readable medium coupled to the processor, the computer readable medium comprising code, executable by the processor for performing the functionality described in further detail below. The server computer may send and receive over-the-air (OTA) messages to a digital wallet application stored on the first device 110 and/or the second device 190.

The token server 170 may receive the token and the real credential from the application provider computer 180. The token server 170 may link the real credential and the token in a database, such as a token vault. The token server 170 may facilitate activation of the token so that the token may thereafter be used by the first device 110 in a transaction.

The token server 170 may maintain a stored association (e.g., mapping) between the token and the real credential, such that a token exchange module is able to “translate” the token back to the real credential. In some embodiments, the token is mathematically derived from the real credential. In other embodiments, the token is randomly generated with respect to the real credential, and is simply linked to it in a data table. Regardless of how the token is generated from the real credential and vice versa, the use of a token instead of a real credential during a transaction can provide enhanced security. The token server 170 may comprise a server computer. The server computer may include a processor and a computer readable medium coupled to the processor, the computer readable medium comprising code, executable by the processor for performing the functionality described in further detail below.

Once the token is activated by the token server 170, the token may be used by the first device 110 to interact with the access device 120 in a transaction. For example, the token may be presented by the first device 110 to the access device 120 to initiate a transaction. The access device 120 may forward the token, and/or any other transaction details, to a resource provider computer 130. The resource provider computer 130 may be associated with a resource provider, such as a merchant, an access provider, and/or the like. The resource provider computer 130 may generate an authorization request message for the transaction using the token and the transaction details. The resource provider computer 130 may comprise a server computer. The server computer may include a processor and a computer readable medium coupled to the processor, the computer readable medium comprising code, executable by the processor for performing the functionality described in further detail below.

The resource provider computer 130 may be in communication with a transport computer 140. The transport computer 140 is typically a system for an entity that has a business relationship with another entity (e.g., a bank associated with a particular resource provider computer 130). The transport computer 140 may route an authorization request message for a transaction to the authorizing entity computer 160 via transaction processing computer 150. The transport computer 140 may comprise a server computer. The server computer may include a processor and a computer readable medium coupled to the processor, the computer readable medium comprising code, executable by the processor, for performing the functions described herein.

The transaction processing computer 150 may be associated with one or more service providers. The transaction processing computer 150 may include any entity that provides tokenization and detokenization services. In some embodiments, the transaction processing computer 150 may include the token server 170. In such embodiments, the application provider computer 180 may utilize an application programming interface (API) to communicate with the transaction processing computer 150. The transaction processing computer 150 may comprise a server computer. The server computer may include a processor and a computer readable medium coupled to the processor, the computer readable medium comprising code, executable by the processor, for performing the functions described herein.

In some embodiments, the authorizing entity computer 160 may communicate with the transaction processing computer 450 to authorize transactions. The authorizing entity computer 160 is typically run by a business entity (e.g., a bank) that may have issued the real credential or token used for the transaction. Some systems can perform both authorizing entity computer 160 and transport computer 140 functions. When a transaction involves a real credential (e.g., a payment account) associated with the authorizing entity computer 160, the authorizing entity computer 160 may verify the account and respond with an authorization response message to the transport computer 140 via the transaction processing computer 150, that may be forwarded to the corresponding access device 120. The authorizing entity computer 160 may comprise a server computer. The server computer may include a processor and a computer readable medium coupled to the processor, the computer readable medium comprising code, executable by the processor, for performing the functions described herein.

The transport computer 140, the transaction processing computer 150, and the authorizing entity computer 160 are further configured to perform a clearing and settlement process at a later time after a transaction has been completed (e.g., at the end of the day).

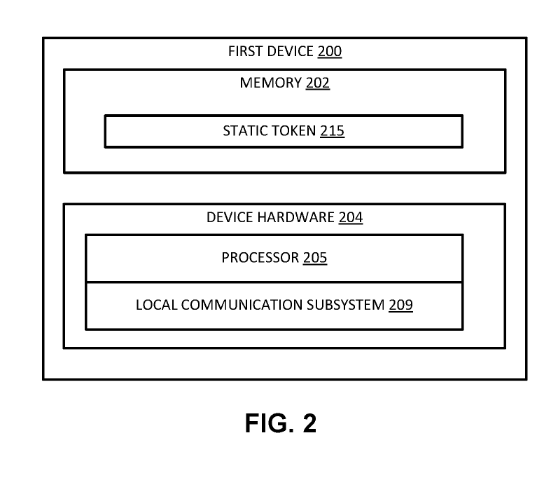

FIG. 2 shows a block diagram of a first device 200 pre-provisioned with a static token according to some embodiments of the present invention. First device 200 may be used, for example, to implement first device 110 of FIG. 1. First device 200 may include device hardware 204 coupled to a memory 202. Device hardware 204 may include a processor 205 and a local communication subsystem 209. The local communication subsystem 209 may support local communications (e.g., near field communication, Bluetooth, Bluetooth LE, etc.), but may not support connections to the Internet in some embodiments. Thus, local communication subsystem 209 may include one or more RF transceivers and/or connectors that can be used by the first device 200 to communicate with other devices (e.g., the second device 190 and/or the second device 300). In some embodiments, the first device 200 may include a radio frequency blocking sleeve protecting the local communication subsystem 209, such that unauthorized access to the memory 202 can be prevented.

Processor 205 can be implemented as one or more integrated circuits (e.g., one or more single core or multicore microprocessors and/or microcontrollers), and is used to control the operation of the first device 200. Processor 205 can execute a variety of programs in response to program code or computer-readable code stored in memory 202, and can maintain multiple concurrently executing programs or processes.

Memory 202 can be implemented using any combination of any number of non-volatile memories (e.g., flash memory) and volatile memories (e.g., DRAM, SRAM), or any other non-transitory storage medium, or a combination thereof media. Memory 202 may store a static token 215. The static token 215 may be pre-provisioned on the first device 200. For example, the static token 215 may be provisioned on the first device 200 during manufacturing of the first device 200. The static token 215 may be static in that its value is pre-programmed and cannot be changed through reprogramming. The static token 215 may be provided to other systems or devices using the local communication subsystem 209 and the processor 205.

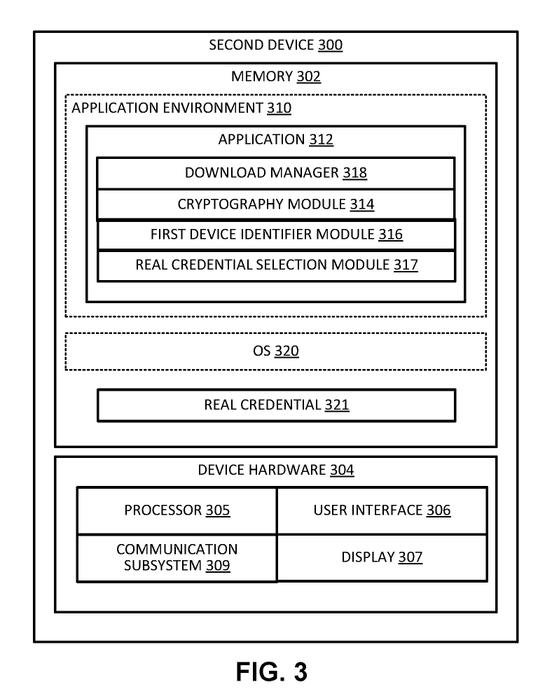

FIG. 3 shows a block diagram of a second device 300 for maintaining the static token according to some embodiments of the present invention. Second device 300 can be used, for example, to implement second device 190 of FIG. 1. Second device 300 may include device hardware 304 coupled to a memory 302. Device hardware 304 may include a processor 305, a communication subsystem 309, and a user interface 306. In some embodiments, device hardware 304 may include a display 307 (which can be part of user interface 306).

Processor 305 can be implemented as one or more integrated circuits (e.g., one or more single core or multicore microprocessors and/or microcontrollers), and is used to control the operation of the second device 300. Processor 305 can execute a variety of programs in response to program code or computer-readable code stored in memory 302, and can maintain multiple concurrently executing programs or processes. Communication subsystem 309 may include one or more RF transceivers and/or connectors that can be used by second device 300 to communicate with other devices (e.g., the first device 110 and/or the first device 200) and/or to connect with external networks (e.g., to connect to the application provider computer 180 and/or the application provider computer 400). User interface 306 can include any combination of input and output elements to allow a user to interact with and invoke the functionalities of the second device 300. In some embodiments, user interface 306 may include a component such as display 307 that can be used for both input and output functions.

Memory 302 can be implemented using any combination of any number of non-volatile memories (e.g., flash memory) and volatile memories (e.g., DRAM, SRAM), or any other non-transitory storage medium, or a combination thereof media. Memory 302 may store an operating system (OS) 320 and an application environment 310 where one or more applications reside including application 312 to be executed by processor 305. Memory 302 may store a real credential 321. The real credential 321 may be provisioned on the second device 300. For example, the real credential 321 may be registered with the application 312. The real credential 321 may be dynamic in that its value can be changed through reprogramming. The real credential 321 may be provided to other systems or devices using the communication subsystem 309 and the processor 305.

Application 312 can be an application that uses, accesses, and/or stores real credentials or tokens (e.g., real credential 321). For example, application 312 can be a wallet or payment application that uses real credentials or tokens to conduct transactions via the second device 300. In a further example, application 312 can be a wallet or payment application that uses real credentials and device identifiers to facilitate activation of tokens. In some embodiments, access to application 312 by a user can be protected by user authentication data such as a password, passcode, PIN, etc. For example, when a user attempts to launch or execute application 312, the user may be requested to enter valid user authentication data before the user can access application 312. Application 312 may include a download manager 318, a cryptography module 314, a first device identifier module 316, and a real credential selection module 317. In some embodiments, one or more of these components can be provided by another application or component that is not part of application 312.

Download manager 318 can be configured to, in conjunction with processor 305, provide functionalities to communicate with an application provider associated with application 312 (such as application provider computer 180 of FIG. 1) to download information via the application provider. Download manager 318 may, in conjunction with processor 305, request or otherwise manage the acquisition, activation and/or storage of real credentials and/or tokens. For example, download manager 318 may, in conjunction with processor 305, request activation of a token via the application provider associated with application 312. Upon activation, the token may be associated with a selected real credential. In some embodiments, the real credential provided to the application provider can be provided in an encrypted form. For example, the real credential can be encrypted with a session key generated by the second device 300. Download manager 318 may also, in conjunction with processor 305, receive, from the application provider, confirmation of the activation.

Cryptography module 314, in conjunction with processor 305, may provide cryptographic functionalities for application 312. For example, cryptography module 314 may, in conjunction with processor 305, implement and perform encryption/decryption operations for application 312 using encryption algorithms such as DES, AES, TDES/TDEA, or the like, and/or hash functions such as SHA, or the like. For example, when application 312 accesses data stores within memory 302 to retrieve and use real credentials or tokens stored therein, application 312 may invoke cryptography module 314 to, in conjunction with processor 305, decrypt the session key that is used to encrypt the stored real credentials or token, and then decrypt the real credential or token using the decrypted session key. The decrypted real credential or token can then be used by application 312.

First device identifier module 316 may, in conjunction with processor 305, receive as input an identifier associated with the first device. The first device identifier module 316 may receive the identifier according to any method. For example, the first device identifier module 316 may receive a serial number as input from a keyboard on the user interface 306. In another example, the first device identifier module 316 may, in conjunction with the processor 305, receive data from a camera or other optical scanner (not shown) in device hardware 304 that may scan and interpret or translate a code (e.g., a QR code, a barcode, etc.) into a serial number or other alphanumeric identifier. First device identifier module 316 may then, in conjunction with processor 305, send the identifier to an application provider (e.g., the application provider computer 180).

Real credential selection module 317 may, in conjunction with processor 305, display real credentials that are registered with the application 312 on the display 307. Real credential selection module 317 may additionally, in conjunction with processor 305, receive a selection of a real credential from the displayed real credentials via user interface 306 (e.g., a keyboard) and/or through display 307 (e.g., a touch screen). Real credential selection module 317 may then send the selected real credential to an application provider (e.g., the application provider computer 180). In some embodiments, the first device identifier and the selected real credential may be sent in a single data packet to the application provider from the second device 300.

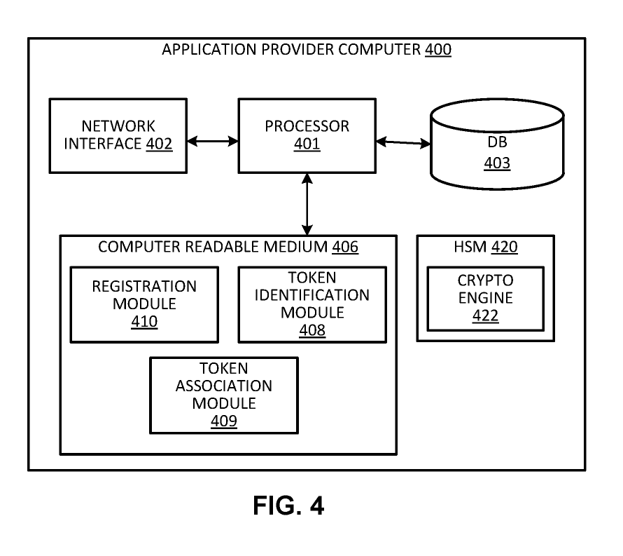

FIG. 4 illustrates a block diagram of an application provider computer 400 associated with an application provider, according to some embodiments. For example, application provider computer 400 can be application provider computer 180 of FIG. 1, who provides a software application or services associated with the application for a second device 190. Application provider computer 400 may include a processor 401 coupled to a network interface 402 and a computer readable medium 406. In some embodiments, application provider computer 400 may also include a hardware security module (HSM) 420. Application provider computer 400 may also include or otherwise have access to a database 403 that may be internal or external to application provider computer 400.

Processor 401 may include one or more microprocessors to execute program components for performing the token activation request functions of application provider computer 400. Network interface 402 can be configured to connect to one or more communication networks to allow application provider computer 400 to communicate with other entities such as the second device operated by a user, a token server, etc. Computer readable medium 406 may include any combination of one or more volatile and/or non-volatile memories, for example, RAM, DRAM, SRAM, ROM, flash, or any other suitable memory components. Computer readable medium 406 may store code executable by the processor 401 for implementing some or all of the token activation request functions of application provider computer 400. For example, computer readable medium 406 may include code implementing a registration module 410, a token identification module 408 and a token association module 409. In some embodiments, application provider computer 400 may also include a hardware security module (HSM) 420 to implement a cryptography engine 422.

Registration module 410 may, in conjunction with processor 401, register users with application provider computer 400. For example, a user can be registered with the application provider by providing registration module 410 with user identifying information to identify the user, device information such as a device identifier associated with the user's communication device on which an application associated with the application provider is installed, account information such as an account identifier associated with the user's account, etc. In some embodiments, a user may set up user authentication data (e.g., password, passcode, PIN, etc.) via registration module 410. The user authentication data can be used by application provider computer 400 to authenticate the user when the application on the user's communication device communicates with application provider computer 400. Registration module 410 may also, in conjunction with processor 401, allow a user to change or update the user authentication data. The registration information can be stored in a database 403. In some embodiments, the registration process can be carried out when the user first downloads the application for installation on the user's communication device, or when the user first launches and executes the application.

Token identification module 408 is configured to, in conjunction with processor 401, receive a first device identifier from a second device. Upon receiving the first device identifier from the second device, token identification module 408 may, in conjunction with processor 401, retrieve a corresponding token from the database 403 (e.g., by using a look-up table). The token retrieved from the database 403 may correspond to the token pre-provisioned onto the first device. Token identification module 408 may provide the retrieved token to the token association module 409.

Token association module 409 is configured to, in conjunction with processor 401, receive a selected real credential from the second device. Upon receiving the selected real credential from the second device, token association module 409 may associate the token received from the token identification module 408 with the selected real credential. In some embodiments, the token association module 409 may further store the association in the database 403. The token association module 409 may route the selected real credential and the token to a token server, in order to facilitate activation of the token.

In some embodiments, the token association module 409 is configured to, in conjunction with processor 401, perform authentication procedures prior to sending the selected real credential and the token to the token server. The authentication procedures may include, for example, verification of the authenticity of the selected real credential, verification of the authenticity of the second device, and/or verification of the authenticity of the user of the second device requesting activation of the token. For example, the token association module 409 may, in conjunction with processor 401, authenticate the user, the second device, and/or the real credential by verifying the user authentication data and a second device identifier against previously registered information stored in the database 403. Once authenticated, the token association module 409 may route the selected real credential and the token to the token server, in order to facilitate activation of the token. In some embodiments, the token association module 409 may include a flag or some other indicator indicating that the user, the second device, and/or the real credential has been authenticated.

Cryptography engine 422 may, in conjunction with processor 401, provide cryptographic functionalities for application provider computer 400. In some embodiments, cryptography engine 422 can be implemented in HSM 420, which is a specialized hardware component used to perform cryptographic operations and manage cryptographic keys. Cryptography engine 422 may, in conjunction with processor 401, implement and perform encryption/decryption operations for application provider computer 400 using encryption algorithms such as such as AES, DES, TDES/TDEA, or other suitable encryption algorithms using cryptographic keys of any length (e.g., 56-bit, 128-bit, 169-bit, 192-bit, 256-bit, etc.). In some embodiments, cryptography engine 422 can also perform hash calculations using hash functions such as secure hash algorithm (SHA), or the like. For example, when application provider computer 400 receives a session key used for encrypting real credentials or tokens from a token server, application provider computer 400 may invoke cryptography engine 422 to encrypt the session key, such that session key can be provided to the application on the communication device in an encrypted form. In some embodiments, the session key can be encrypted using a hash value that is computed over the user authentication data associated with the user requesting the real credential or token.

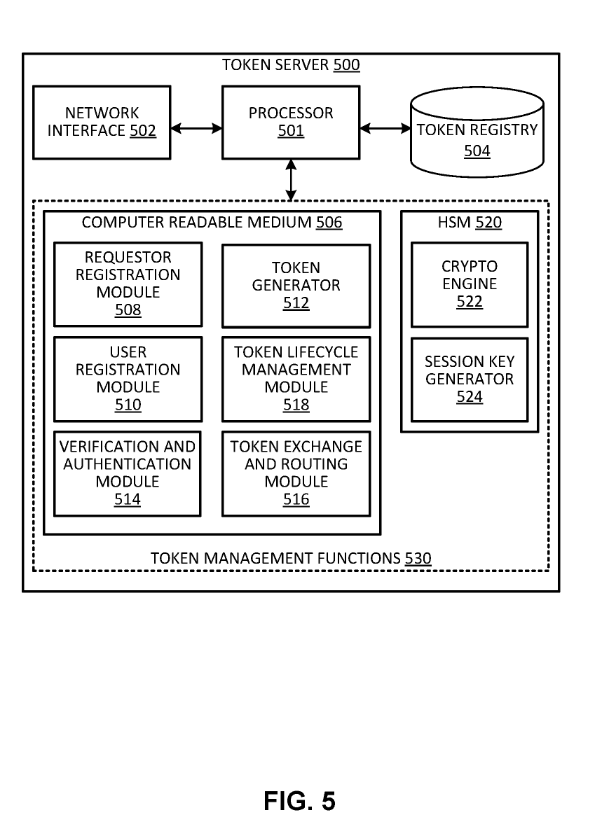

FIG. 5 shows a block diagram of a token server 500 (e.g., token server 170 of FIG. 1) according to some embodiments of the present invention. Token server 500 may be used to generate, activate, maintain and manage static tokens to be pre-provisioned into first devices, as described further herein. In some embodiments, one or more token servers 500 can be used, for example, to implement a network token system. Token server 500 may include a processor 501 coupled to a network interface 502 and a computer readable medium 506. In some embodiments, token server 500 may also include a hardware security module (HSM) 520. Token server 500 may also include a token registry 504 that may be internal or external to token server 500.

Processor 501 may include one or more microprocessors to execute program components for performing the token management functions 530 of token server 500. Network interface 502 may be configured to connect to one or more communication networks to allow token server 500 to communicate with other entities such as a communication device operated by a user, an application provider computer or a token request computer, resource provider computer, transport computer, transaction processing computer, authorizing entity computer, etc. Computer readable medium 506 may include any combination of one or more volatile and/or non-volatile memories, for example, RAM, DRAM, SRAM, ROM, flash, or any other suitable memory components. Computer readable medium 506 may store code executable by the processor 501 for implementing some or all of the token management functions 530 of token server 500 described herein. For example, computer readable medium 506 may include a requestor registration module 508, a user registration module 510, a token generator 512, a verification and authentication module 514, a token exchange and routing module 516, and a token life-cycle management module 518.

Requestor registration module 508 may, in conjunction with processor 501, register a token requestor entity (e.g., application provider) with the token registry 504, and generate a token requestor identifier (ID) for the registered entity. Each registered entity can use their respective token requestor ID as part of a token service request to facilitate identification and validation of the entity. In some embodiments, a token requestor entity may provide token requestor information to the requestor registration module 508 such as an entity name, contact information, an entity type (e.g., merchant, wallet provider, payment service provider, issuer, payment enabler, acquirer, etc.). In some embodiments in which the token is transaction related, the token requestor information may also include token presentment modes (e.g., scan, contactless, e-commerce, etc.), token type (e.g., static/dynamic, payment/non-payment), integration and connectivity parameters, and services subscribed (e.g., token request, authentication and verification, life-cycle management, etc.) and any other relevant information for the onboarding process.

User registration module 510 may, in conjunction with processor 501, perform registration of users and accounts of the users. In some embodiments, token server 500 may allow authorized entities to register consumer accounts (e.g., payment or financial accounts) with the network token system on behalf of the users. For example, a registered token requestor may provide a token requestor ID (e.g., received at the time of registration from the requestor registration module 508), an account identifier or other sensitive information or sensitive information identifier for which a token can substitute, a consumer name and contact information, device identifier of the consumer's communication device, a token type, and any other relevant information for individual account registration or bulk account registration. In some embodiments, user registration module 510 may, in conjunction with processor 501, store the account details and sensitive information in token registry 504 for all successful activation and registration requests. In some embodiment, an authorized entity may also unregister users and accounts by providing the necessary information to token server 500.

Token generator 512 can be programmed to, in conjunction with processor 501, generate a token or retrieve a real credential in response to processing a request for a token or real credential from a token requestor (e.g., an application provider), in conjunction with processor 501. In some embodiments, the token generator 512 may pre-generate tokens that are not yet associated with real credentials to be pre-provisioned into first devices, and later activated by second devices. Further, token generator 512 can be programmed to, in conjunction with processor 501, generate verification values, such as CVNs and TAVVs. In some embodiments, token generator 512 may receive a token requestor ID and an account identifier or sensitive information identifier. In some embodiments, token generator 512 may also, in conjunction with processor 501, receive optional information such as a user name, a user address and zip code, a requested token or sensitive information type (e.g., static, dynamic, non-payment, etc.), device identifier, and/or suitable information. In some embodiments, token generator 512 may, in conjunction with processor 501, generate a response with the requested token or requested real credential, a token expiration date associated with the token, and/or a token assurance level associated with the token. In some embodiments, token generator 512 may, in conjunction with processor 501, validate the token requestor ID and maintain the correlation between the token, the sensitive information or account identifier being substituted by the token, and the associated token requestor. In some embodiments, token generator 512 may, in conjunction with processor 501, determine if a token already exists in token registry 504 for a token request before generating a new token. In some embodiments, if a token cannot be provisioned, the token response may include a corresponding reason code. In some embodiments, token generator 512 may also, in conjunction with processor 501, provide an interface to the token requestors to submit a bulk token request file.

Token generator 512 may, in conjunction with processor 501, determine a token range to assign the token. The token range may be assigned based on whether the authorizing entity is provisioning the token (e.g., issuer assigned token range) or the transaction processing computer is provisioning the token on behalf of the authorizing entity (e.g., transaction processing network assigned token range). As an example, if the transaction processing network assigned token range includes “442400000-442400250,” then “4424000000005382” may be assigned as a token value. Token registry 504 may, in conjunction with processor 501, store the relationship of the token range to the account identifier, and a token add record may be logged. In some embodiments, token generator 512 may, in conjunction with processor 501, consider the token range list associated with the account identifier range before assigning a token.

Verification and authentication module 514 may, in conjunction with processor 501, be configured to execute a consumer verification and authentication process, and determine a token assurance level based on the outcome of the verification and authentication process. For example, the verification and authentication module 514 can perform consumer authentication and verification through a configured authentication scheme. In some embodiments, the authentication scheme may include verification of the account identifier, verification values, and the expiration date based on the customer information stored in a database associated with the transaction processing network. In some embodiments, the authentication scheme may include direct verification of the consumer by the issuer using consumer credentials for their online banking system.

In some embodiments, the authentication scheme may include verification of the consumer credentials through the issuer ACS (Access Control Server). For example, the issuer ACS service may be part of an authentication protocol such as 3-D secure protocol by Visa®. The ACS server may be associated with an issuer that may include registered consumer account and access information. The ACS can give issuers the ability to authenticate a consumer during an online purchase, thereby reducing the likelihood of fraudulent use of the consumer account. For example, the ACS can validate that the consumer is registered, performs consumer verification at the time of the transaction, and provides digitally signed responses to the merchants. In some embodiments, the authentication scheme may include verification of the account using a transaction processing network consumer authentication service (e.g., Visa™ Consumer Authentication Service (VCAS)). For example, the VCAS service can authenticate the consumer on-behalf of the issuer prior to the authorization process.

In some embodiments, user registration, token generation, and verification and authentication may be performed as part of processing a single token request process. In some embodiments, for bulk requests, user registration and token generation may be performed by processing a bulk file from the token requestor. In such embodiments, consumer verification and authentication may be performed in a separate step. In some embodiments, the token requestor can request that the authentication and verification process be performed independently multiple times for a particular account to reflect any changes to the levels of assurance for the token over time.

Token exchange and routing module 516 may, in conjunction with the processor 501, process requests for the underlying real credential (e.g., an account identifier) associated with a given token. For example, a transaction processing computer, acquirer, issuer, etc. may issue a request for a token exchange during processing of a transaction. Token exchange and routing module 516 may, in conjunction with the processor 501, validate that the requesting entity is entitled to make a request for a token exchange. In some embodiments, token exchange and routing module 516 may, in conjunction with the processor 501, validate the real credential (or other sensitive information) to token mapping and presentment mode based on the transaction timestamp and the token expiration timestamp. Token exchange and routing module 516 may, in conjunction with the processor 501, retrieve the account identifier (or other real credential) from token registry 504, and provide it along with the assurance level to the requesting entity. In some embodiments, if the account identifier (or other sensitive information) to token mapping is not valid for the transaction timestamp and presentment mode, an error message may be provided.

Token life-cycle management module 518 may, in conjunction with the processor 501, perform life-cycle operations on the tokens managed by token server 500. Life-cycle operations may include canceling a token, activating and deactivating a token, updating token attributes, renewing token with a new expiration date, etc. For example, token life-cycle management module 518 may, in conjunction with the processor 501, activate static tokens pre-provisioned on first devices. Activation of the static token may include receiving the token and a selected real credential from an application provider, and storing the token in association with the real credential in the token registry 504 for later exchange by the token exchange and routing module 516. In some embodiments, the token life-cycle management module 518 may only activate the token if a flag or other indicator indicates that the user, the second device, and/or the real credential has been authenticated by the application provider or another entity.

In some embodiments, a token requestor entity may provide a token requestor ID, a token number, a life-cycle operation identifier and one or more token attributes to token server 500 to perform the requested life-cycle operation on a given token. Token life-cycle management module 518 may, in conjunction with the processor 501, verify the token requestor ID and the token association based on information in token registry 504. Token life-cycle management module 518 may, in conjunction with the processor 501, perform the requested life-cycle operation on a given token, and update the corresponding associations in token registry 504. Examples of life-cycle operation may include a token activation operation to activate an inactive, suspended, or temporarily locked token and its associations; a token de-activation operation to temporarily lock or suspend a token; a cancel token operation to permanently mark a token and its associations as deleted to prevent any future transactions, etc. In some embodiments, a deleted token may be used during returns/chargebacks if the same token was used to submit the corresponding original transactions.

According to some embodiments, token server 500 may include an HSM 520 to perform secure functions such as encryption and decryption operations and generation of cryptographic keys used for the encryption and decryption operations. For example, HSM 520 may include a cryptography engine 522 to execute encryption algorithms such as AES, DES, TDES/TDEA, or other suitable encryption algorithms using cryptographic keys of any length (e.g., 56-bit, 128-bit, 169-bit, 192-bit, 256-bit, etc.). HSM 520 may also implement a session key generator 524 to generate a session key for each token or real credential request that token server 500 processes. The generated session key can be used to encrypt a token or real credential generated or retrieved for the request, and the token or real credential can be provided to the token requestor in an encrypted form. For example, for each request that token server 500 receives and processes, session key generator 524 may generate a session key that can be unique for each request received from the particular token requestor, or unique to each request associate with a particular user or account. In some embodiments, the session key can be the same or different than the encryption key that is used to establish the secure communication channel (e.g., TLS, SSL, etc.) between the token requestor and token server 500. Token generator 512 may generate or otherwise retrieve a token or real credential to fulfill the request. The session key can be used by cryptography engine 522 to encrypt that token or real credential using an encryption algorithm, and the encrypted token or real credential can be provided to the token requestor. In some embodiments, the generated session key is also provided to the token requestor with the encrypted token or real credential.

Although token server 500 and application provider computer 400 have been described with a HSM implementing only some of their functions, it should be understood that other functionalities of the respective computers (e.g., token generation, storage and activation) can be implemented inside a HSM as well. Furthermore, some or all of the respective HSM functionalities can also be implemented outside of a HSM.

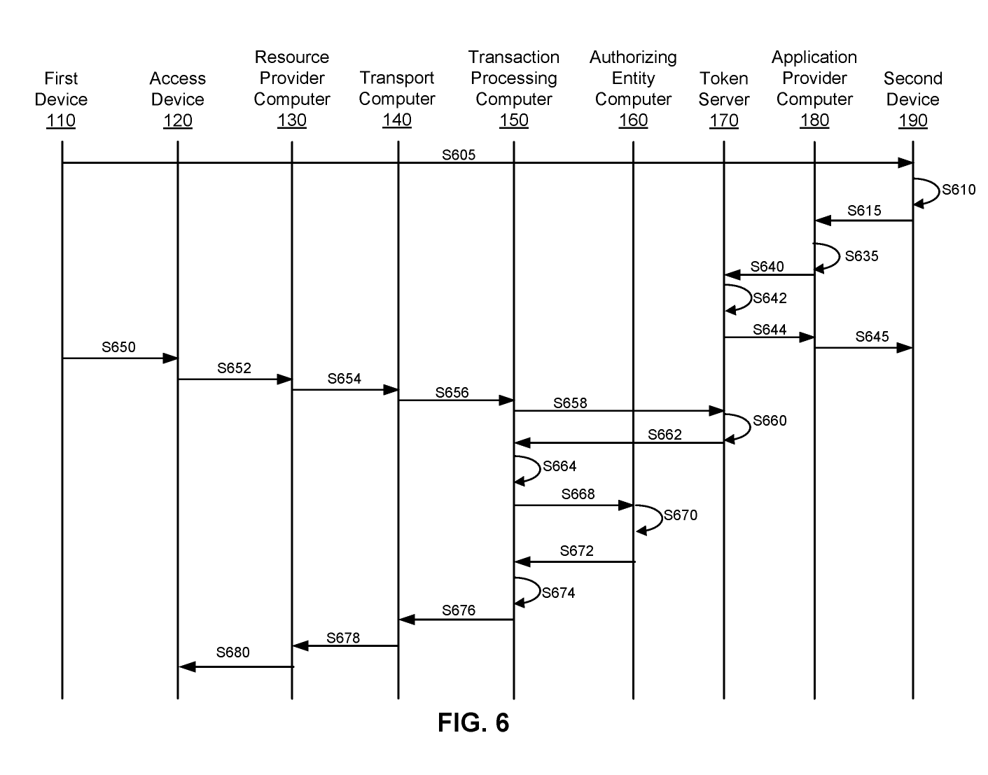

FIG. 6 shows a flow diagram of a transaction method for processing static tokens representing dynamic real credentials according to some embodiments of the present invention. The method of FIG. 6 may be implemented by the first device 110, the access device 120, the resource provider computer 130, the transport computer 140, the transaction processing computer 150, the authorizing entity computer 160, the token server 170, the application provider computer 180, and the second device 190. The first device 110 may be pre-provisioned with a token and may include a first device identifier, such as a serial number, that is displayable on or with the first device 110. In some embodiments, the serial number may be covered by a scratch off label or other label to protect the value from being misused by unauthorized parties.

At step S605, the second device 190 may be used to read a first device identifier associated with the first device 110. The first device identifier may be input into the second device 190 in any suitable fashion. For example, the first device identifier may be input into the second device 190 using a keyboard (e.g., if the first device identifier is a serial number or other alphanumeric code). In another example, the first device identifier may be input into the second device 190 using a camera or other optical scanner (e.g., if the first device identifier is encoded in a QR code, a barcode, or other non-alphanumeric code). In still another example, the first device identifier may be transmitted from the first device 110 to the second device 190 using local communications (e.g., near field communication, Bluetooth, Bluetooth LE, etc.). In still another example, the first device identifier may be input into the second device 190 by reading the first device identifier into a microphone and interpreting the speech using voice recognition technology.

At step S610, the second device 190 may display a list of real credentials registered with an application on the second device 190, receive a selection of a real credential from the list, and may then retrieve the selected real credential from memory. Alternatively, at step S610, the second device 190 may receive a real credential (e.g., an account number, expiration date, and/or verification value) that was not pre-registered. At step S615, the second device 190 may send the first device identifier and the real credential to the application provider computer 180.

The application provider computer 180 may store associations of device identifiers and their corresponding pre-provisioned tokens. In some embodiments, the application provider computer 180 may be the requestor of the pre-provisioned tokens. Thus, at step S635, the application provider computer 180 may use the first device identifier to retrieve the corresponding pre-provisioned token. The application provider computer 180 may link the retrieved token with the selected real credential. At step S640, the application provider computer 180 may transmit the token and the real credential to the token server 170.

In some embodiments, before transmitting the token and the real credential to the token server 170, the application provider computer 180 may authenticate the user requesting activation of the token via the second device 190, the second device 190, and/or the selected real credential. The application provider computer 180 may perform this authentication by comparing information received from the second device 190 to information registered with the application provider computer 180. In some embodiments, the application provider computer 180 may contact a third party to perform one or more authentication procedures. For example, the application provider computer 180 may transmit the real credential (e.g., an account number, a verification value, and an expiration date) to the authorizing entity computer 160 to verify that the real credential is valid. Once authentication has been performed, the application provider computer 180 may include a flag or other indicator indicating that the user, device, and/or real credential has been authenticated when transmitting the token and real credential to the token server 170 at step S640.

At step S642, the token server 170 may activate the token. In order to activate the token, the token server 170 may receive the token and the real credential from the application provider computer 180, and store the token in association with the real credential in a token registry. Once stored in the token registry, the token may be exchanged for the real credential during processing of a transaction using the token. In some embodiments, the token server 170 may only activate the token if a flag or other indicator indicates that the user, the second device, and/or the real credential has been authenticated by the application provider computer 180 or another entity (e.g., the authorizing entity computer 160).

At step S644, the token server 170 may send confirmation of the activation of the token to the application provider computer 180. At step S645, the application provider computer 180 may send confirmation of the activation of the token to the second device 190.

Once activated, the token pre-provisioned in the first device 110 may be used in transactions. For example, at step S650, the first device 110 may interact with an access device 120 in a transaction. For example, the first device 110 may use local communications (e.g., near field communication, Bluetooth, etc.) to communicate the token to the access device 120. At step S652, the access device 120 may transmit the token received from the first device 110, as well as any transaction details (e.g., time, date, amount, etc.), to the resource provider computer 130. The resource provider computer 130 may use the token and the transaction details to generate an authorization request message including the token, then transmit the authorization request message to the transport computer 140 at step S654. At step S656, the transport computer 140 may transmit the authorization request message including the token to the transaction processing computer 150.

At step S658, the transaction processing computer 150 receives the authorization request message including the token, extracts the token from the authorization request message, and transmits the token to the token server 170. At step S660, the token server 170 retrieves the real credential corresponding to the token from a token vault or token registry. The real credential may be stored in association with the token, for example, in a look-up table. At step S662, the token server 170 returns the real credential to the transaction processing computer 150. At step S664, the transaction processing computer 150 replaces the token with the real credential in the authorization request message. At step S668, the transaction processing computer 150 transmits the authorization request message including the real credential to the authorizing entity computer 160.

At step S670, the authorizing entity computer 160 may make an authorization decision on the authorization request message. For example, the authorizing entity computer 160 may determine whether or not to authorize the transaction based on whether the real credential is valid and/or, in the case of payment transactions, whether there are sufficient available funds for the transaction. The authorizing entity computer 160 may generate an authorization response message including the real credential and the authorization decision. At step S672, the authorizing entity computer 160 may transmit the authorization response message including the real credential to the transaction processing computer 150.

At step S674, the transaction processing computer 150 may receive the authorization response message including the real credential, and replace the real credential with the token in the authorization response message. Thus, the real credential may not be exposed to downstream entities that did not previously have access to the real credential (e.g., the transport computer 140, the resource provider computer 130, and/or the access device 120). At step S676, the transaction processing computer 150 transmits the authorization response message including the token to the transport computer 140. At step S678, the transport computer 140 transmits the authorization response message including the token to the resource provider computer 130. At step S680, the resource provider computer 130 transmits the authorization response message including the token (and/or some other indication of authorization) to the access device 120.

At the end of the day or at another suitable time, the transport computer 140, the transaction processing computer 150, and the authorizing entity computer 160 may perform a clearing and settlement process after the transaction has been completed.

In some embodiments, the real credential associated with the static token may be dynamically changed. In other words, at any time before or after a transaction is conducted using the activated token, the second device 190 may be used to select a different real credential to instead associate with the activated token. In some embodiments, before the newly selected real credential may be used in a transaction, authentication procedures may be conducted, as described further herein.

The systems and methods described herein may be implemented in a variety of contexts. For example, in a payment transaction, the token may be a payment token that is pre-provisioned on the first device. The real credential selected by the second device may correspond to a primary account number (PAN), e.g., a bank account number, a credit card number, etc. The token may be transmitted through local communication (e.g., near field communication, Bluetooth, etc.) to an access device to initiate or during a payment transaction (e.g., a purchase of goods and/or services).

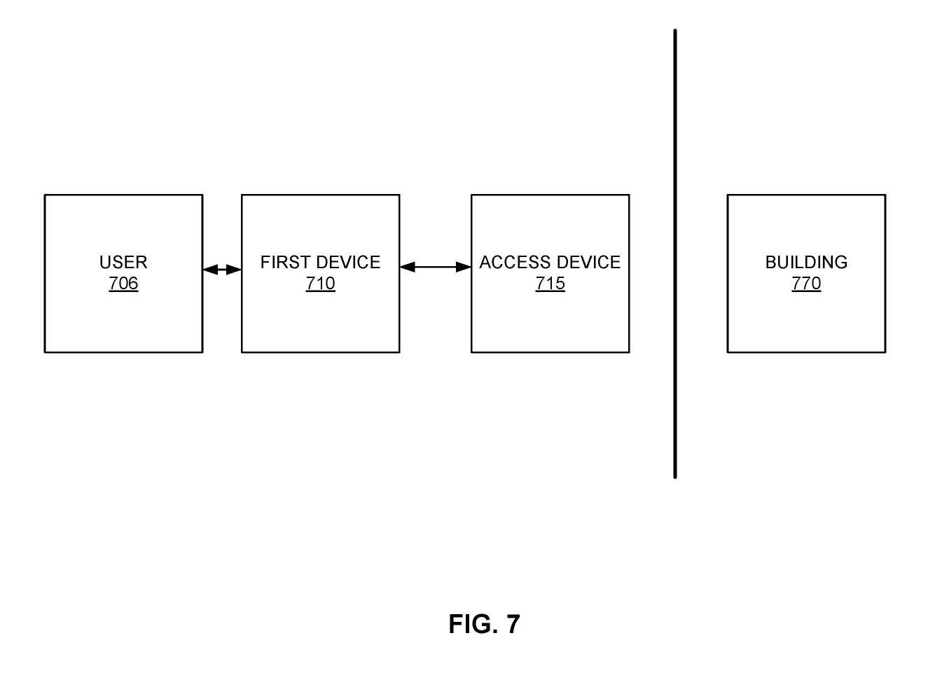

The systems and methods described herein may also be used in access transactions. For example, FIG. 7 shows a block diagram of a building access system according to some embodiments of the invention. A user 706 may operate a first device 710 (e.g., first device 110 of FIG. 1 and/or first device 200 of FIG. 2) having a pre-provisioned token. The token may have been previously associated with a real credential and activated as facilitated by a second device (not shown). The first device 710 may interact with the access device 715 to transmit the token to the access device 715.

The access device 715 may communicate with a remotely located server computer (not shown). The remotely located server computer may exchange the token for the associated real credential to determine whether access should be granted to building 770, and may transmit a signal indicating this back to the access device 715. The access device 715 may then proceed to allow or deny access by the user 706 to the building 770, in accordance with the sensitive information.

The systems and methods described herein provide a number of advantages. For example, the use of a token within the first device to conduct transactions hides the real credential from resource providers, enhancing the security of transactions. For example, not only does this reduce the risk of fraud by the resource provider, but also minimizes interception and misuse of the real credential by reducing the number of parties to which the real credential is communicated. In addition, the mapping from the token to the real credential is limited to a token server. The token server may be highly secured and totally isolated from other transaction processing entities, further reducing the risk of fraud and interception of the real credential by unauthorized parties.

Further, according to some embodiments, token may be pre-provisioned or manufactured into any device, including limited functionality devices. In other words, the systems and methods described herein do not require the pre-provisioned device to have access to the Internet (or other remote network capabilities), and/or to have a sophisticated user interface.

Although the token pre-provisioned into the limited functionality device may be static, the real credential associated with the static token can be dynamically changed using a second device (e.g., an enhanced functionality device). Thus, the real credential associated with the static token can be updated or replaced, e.g., upon expiration or cancellation of a previous real credential, when obtaining a new real credential, or when use of a different real credential is desired. The real credential associated with the static token can be changed at any time (e.g., between each transaction), so that multiple different limited functionality devices, each corresponding to a different real credential, are not required.

A computer system may be used to implement any of the entities or components described above. The subsystems of the computer system may be interconnected via a system bus. Additional subsystems such as a printer, keyboard, fixed disk (or other memory comprising computer readable media), monitor, which is coupled to display adapter, and others may be used. Peripherals and input/output (I/O) devices, which couple to an I/O controller (which can be a processor or other suitable controller), can be connected to the computer system by any number of means known in the art, such as a serial port. For example, a serial port or external interface can be used to connect the computer apparatus to a wide area network such as the Internet, a mouse input device, or a scanner. The interconnection via system bus allows the central processor to communicate with each subsystem and to control the execution of instructions from system memory or the fixed disk, as well as the exchange of information between subsystems. The system memory and/or the fixed disk may embody a computer readable medium. In some embodiments, the monitor may be a touch sensitive display screen.

A computer system can include a plurality of the same components or subsystems, e.g., connected together by an external interface or by an internal interface. In some embodiments, computer systems, subsystem, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g. an application specific integrated circuit or field programmable gate array) and/or using computer software with a generally programmable processor in a modular or integrated manner. As used herein, a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

Like reference numerals are used to indicate like elements throughout the figures.

What is claimed:

1. A method comprising:
receiving, by a server computer, a first device identifier associated with a first device from a second device, wherein the first device identifier is stored in association with a token, and wherein the token is pre-provisioned in the first device;
receiving, by the server computer, a real credential from the second device;
linking, by the server computer, the real credential and the token; and
facilitating, by the server computer, activation of the token, wherein the token is thereafter used by the first device to interact with an access device in a transaction.

2. The method of claim 1, wherein the real credential is a first real credential, wherein the transaction is a first transaction, wherein the access device is a first access device, and wherein the method further comprises:
receiving, by the server computer, a second real credential from the second device; and
replacing, by the server computer, the first real credential with the second real credential, wherein the second real credential is linked with the token, and wherein the token is thereafter used by the first device to interact with a second access device in a second transaction.

3. The method of claim 1, further comprising, before facilitating activation of the token:
facilitating, by the server computer, authentication procedures.

4. The method of claim 3, wherein the authentication procedures include at least one of verification of the real credential or verification of a user of the second device.

5. The method of claim 1, wherein the first device is a limited functionality device, and wherein the second device is an enhanced functionality device.

6. The method of claim 1, wherein the token is manufactured in the first device.

7. The method of claim 1, wherein the token is exchanged for the real credential during the transaction.

8. The method of claim 1, wherein at least a portion of the first device is protected by a radio frequency blocking sleeve.

9. The method of claim 1, wherein the transaction is an access transaction.

10. A server computer comprising:
a processor; and
a memory coupled to the processor, the memory storing instructions, which when executed by the processor, cause the server computer to perform operations including:
receiving a first device identifier associated with a first device from a second device, wherein the first device identifier is stored in association with a token, and wherein the token is pre-provisioned in the first device;
receiving a real credential from the second device;
linking the real credential and the token; and
facilitating activation of the token, wherein the token is thereafter used by the first device to interact with an access device in a transaction.

11. The server computer of claim 10, wherein the real credential is a first real credential, wherein the transaction is a first transaction, wherein the access device is a first access device, and wherein the operations further include:
receiving a second real credential from the second device; and
replacing the first real credential with the second real credential, wherein the second real credential is linked with the token, and wherein the token is thereafter used by the first device to interact with a second access device in a second transaction.

12. The server computer of claim 10, wherein the operations further include, before facilitating activation of the token:
facilitating, by the server computer, authentication procedures.

13. The server computer of claim 12, wherein the authentication procedures include at least one of verification of the real credential or verification of a user of the second device.

14. The server computer of claim 10, wherein the first device is a limited functionality device, and wherein the second device is an enhanced functionality device.

15. The server computer of claim 10, wherein server computer is remote from the first device, and wherein the first device cannot communicate with the server computer.

16. The server computer of claim 10, wherein the token is manufactured in the first device.

17. The server computer of claim 10, wherein the token is exchanged for the real credential during the transaction.

18. The server computer of claim 9, wherein at least a portion of the first device is protected by a radio frequency blocking sleeve.

19. The server computer of claim 9, wherein the transaction is an access transaction.

20. A method comprising:
receiving, at a second device, input corresponding to a first device identifier associated with a first device, wherein a token is pre-provisioned in the first device, and wherein a server computer stores the first device identifier in association with the token;
receiving, at the second device, a selection of a real credential provisioned on the second device;
transmitting, by the second device, the first device identifier and the real credential to the server computer, wherein the server computer retrieves the token associated with the first device identifier, links the real credential to the token, and facilitates activation of the token, and wherein the token is thereafter used by the first device to interact with an access device in a transaction.
